(19) United States
(12) Patent Application Publication
(10) Pub. No.: US 2011/0161815 A1
(43) Pub. Date: Jun. 30, 2011

(54) COMMUNICATION APPARATUS

(75) Inventor: Hiroki Iwahara, Inagi-shi (JP)

(73) Assignee: KABUSHIKI KAISHA TOSHIBA, Tokyo (JP)

(21) Appl. No.: 12/976,128

(22) Filed: Dec. 22, 2010

(30) Foreign Application Priority Data
Dec. 25, 2009 (JP) 2009-296140

(51) Int. Cl. G06F 3/14

(52) U.S. Cl. 715/716; 715/748

(57) ABSTRACT

According to one embodiment, a communication apparatus includes a rendering module configured to receive a content item from a digital media server connected to a network and to display an image of the received content item on a display screen, a transmission module configured to transmit a service description to a digital media control point connected to the network in response to a request from the digital media control point, the service description describing an action indicating that a playlist can be displayed on the display screen, and a display module configured to display, when a playlist document which describes one or more titles of one or more content items and a playback order of the one or more content items is received from the digital media control point, the one or more titles of the one or more content items based on the playback order on the display screen.

### CROSS-REFERENCE TO RELATED APPLICATIONS

This application is based upon and claims the benefit of priority from Japanese Patent Application No. 2009-296140, filed Dec. 25, 2009; the entire contents of which are incorporated herein by reference.

### FIELD

Embodiments described herein relate generally to a communication apparatus that receives content items from a server through a network and displays the content items received, and a communication apparatus that receives content items from a server and controls an apparatus that displays the content items received.

### BACKGROUND

The Universal Plug and Play Audio and Video (UPnP AV) standards implement the function of identifying media content items between devices connected to a home network.

The UPnP AV system is employed in a system called “digital living network alliance (DLNA).” The DLNA system may be a 3-box model that has a digital media server, a digital media renderer, and a digital control point. The digital media server distributes digital media content items. The digital media renderer plays back the digital media content items. The digital control point controls the digital media server and the digital media renderer.

Windows 7 (trademark) supports UPnP AV and DLNA. Many household electronic apparatuses that can be connected to Windows 7 are therefore expected to come into market soon.

Jpn. Pat. Appln. KOKAI Publication No. 2008-225783 discloses a system, in which any viewer terminal can receive a playlist from a playback data distributor, receive content data from a content distributor via a communication network and playback the content items thus received.

The DLNA system or the UPnP system has indeed regulations in connection with the playlist prepared in the digital media server (DMS). However, the playlist prepared in the digital media controller (DMC) cannot be notified to the digital media renderer (DMR). The DMC therefore needs to have the function of the DMS so that the DMR may refer to the playlist prepared by the DMC. This will increase the manufacturing cost of the CMC.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary diagram showing the configuration of a content distribution system according to an embodiment.

FIG. 2 is an exemplary block diagram showing the configuration of a digital media server, a digital media control point and a digital media renderer, all used in the embodiment.

FIG. 3 is an exemplary diagram showing an example of service description according to the embodiment.

FIG. 4 is an exemplary diagram showing an example of a playlist document according to the embodiment.

FIG. 5 is an exemplary flowchart explaining the sequence of first preparing a playlist of content items and then playing back the content items in accordance with the playlist.

### DETAILED DESCRIPTION

Various embodiments will be described hereinafter with reference to the accompanying drawings.

In general, according to one embodiment of the invention, a communication apparatus includes a rendering module, a transmission module, and a display module. The rendering module is configured to receive a content item from a digital media server connected to a network and to display an image of the received content item on a display screen. The transmission module is configured to transmit a service description to a digital media control point connected to the network in response to a request from the digital media control point, the service description describing an action indicating that a playlist can be displayed on the display screen. The display module is configured to display, when a playlist document which describes one or more titles of one or more content items and a playback order of the one or more content items is received from the digital media control point, the one or more titles of the one or more content items based on the playback order on the display screen.

A first embodiment will be described below.

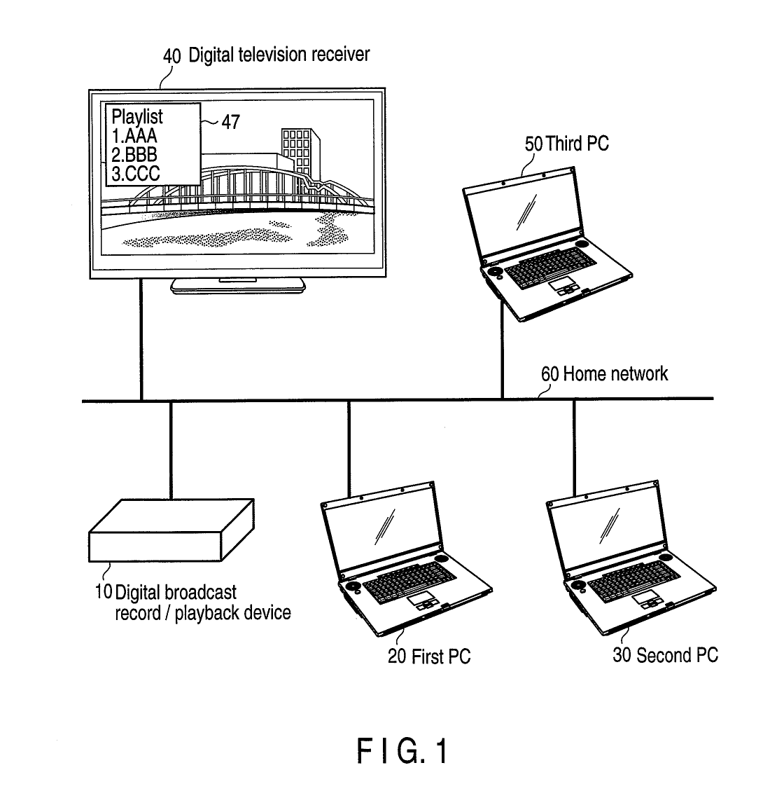

FIG. 1 is a diagram showing the configuration of a content distribution system according to an embodiment.

In the system, a first communication device is implemented by, for example, a personal computer, a second communication device is implemented by a personal computer and a network attached storage (NAS), a third communication device is implemented by, for example, a digital broadcasted program record/playback device, and a fourth communication device is implemented by, for example, a digital television receiver.

As shown in FIG. 1, the second communication device, i.e., digital broadcast record/playback device 10, the second communication device, i.e., first personal computer (1st PC) 20, the second communication device, i.e., second personal computer (2nd PC) 30, and the fourth communication device, i.e., digital television receiver 40, and the first communication device, i.e., third personal computer (3rd PC) 50 are connected to a home network 60.

The digital broadcast record/playback device 10 functions as UPnP AV-standardized digital media server and holds content item AAA. The first personal computer 20 functions as UPnP AV-standardized digital media server and holds content item BBB. The second personal computer 30 functions as UPnP AV-standardized digital media server and holds content item CCC.

The digital television receiver 40 functions as UPnP AV-standardized digital media renderer. Under the control of a digital media control point, the digital television receiver 40 renders the content items stored in the digital broadcast record/playback device 10, first personal computer 20 and second personal computer 30, all functioning as digital media servers.

The third personal computer 50 functions as UPnP AV-standardized digital media control point. If the digital television receiver 40 accords with a playlist action (later described), the third personal computer 50 receives the list of the content items stored in the digital media servers provided on the home network 60. The third personal computer 50 can prepare a playlist document from the content items stored in the digital media servers. The playlist document thus prepared is used to play back content items, one after another, in the order any user has selected them.

Assume that the third personal computer 50 has prepared a playlist describing that the content items AAA, BBB and CCC stored respectively in the digital broadcast record/playback device 10, first personal computer 20 and second personal computer 30 should be played back in the order they are mentioned.

The third personal computer 50 can retrieve any digital media renderer provided on the home network 60. Therefore, it controls the playback performed by the digital television receiver 40, i.e., digital media renderer. Controlled by the digital television receiver 40, the digital television receiver 40 receives content item AAA from the digital broadcast record/playback device 10 and renders content item AAA.

The third personal computer 50 transmits the playlist document it has prepared, to the digital television receiver 40. The digital television receiver 40 receives the playlist document and can then display the playlist when the user inputs instructions to this effect.

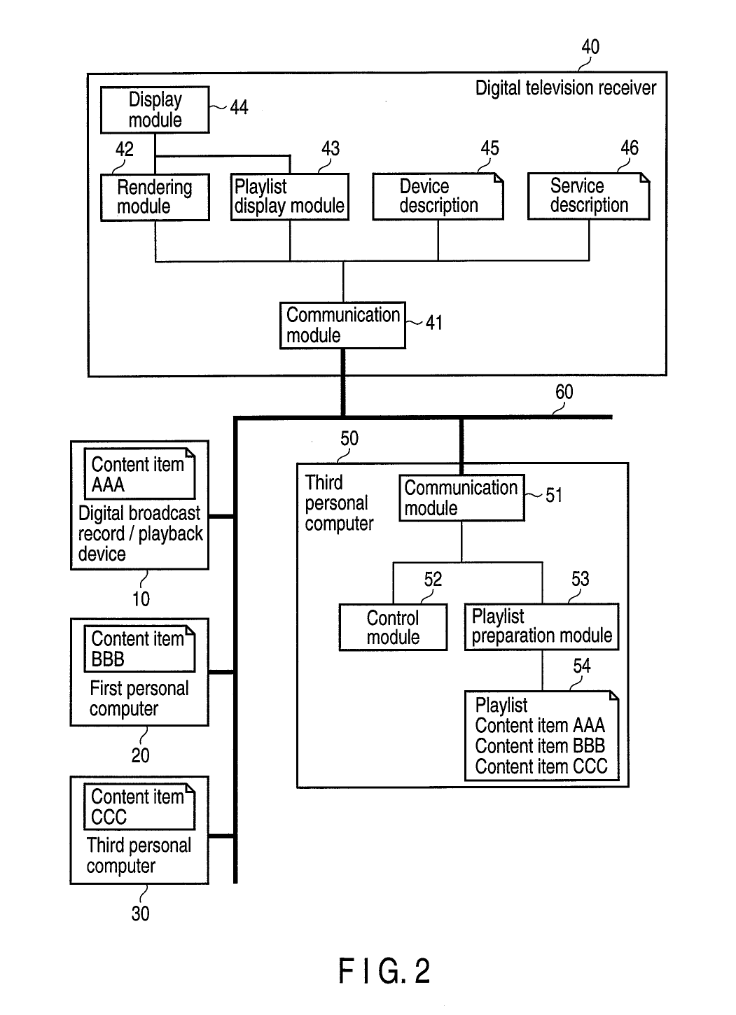

The configurations of the digital television receiver 40 and third personal computer 50 will be described with reference to FIG. 2. FIG. 2 is a block diagram showing the configuration of the digital television receiver 40 (i.e., digital media renderer) and the configuration of the third personal computer 50 (i.e., digital media control point).

The digital television receiver 40 has a communication module 41, a rendering module 42, a playlist display module 43, and a display module 44.

The communication module 41 is a communication device that communicates with the first personal computer 20, second personal computer 30 and digital broadcast record/playback device 10. The rendering module 42 receives from the digital media serves any content item designated by the second personal computer 30 that functions as digital media control point, and plays back the content item in accordance with the instructions coming from the second personal computer 30. The rendering module 42 causes the display module 44 to display the content item. The playlist display module 43 displays a play list 47 as shown in FIG. 1, on the basis of the data transmitted from the second personal computer 30. The display module 44 is a display device such as a liquid crystal display (LCD). The digital television receiver 40 has device description 45 and service description 46. The device description 45 describes the service the receiver 40 can provide, in the Extensible Markup Language (XML). The service description 46 describes the action of each service item, in XML format.

The configuration of the third personal computer 50 will be described.

As shown in FIG. 2, the third personal computer 50 has a communication module 51, a control module 52, and a playlist preparation module 53.

The communication module 51 is a communication device that communicates with the digital broadcast record/playback device 10, first personal computer 20 and second personal computer 30. The control module 52 is a module that has the function of a digital media control point. The playlist preparation module 53 prepares a playlist document 54 described in XML format, in accordance with the instructions the user has input. Further, the playlist preparation module 53 transmits the playlist document 54 to the digital television receiver 40, in response to the instructions the user has input.

The digital broadcast record/playback device 10 holds content item AAA, the first personal computer 20 holds content item BBB, and the second personal computer 30 holds content item CCC.

The means for transmitting the playlist will be explained. The digital television receiver 40, which functions as digital media renderer, transmits the service description 46 to the third personal computer 50 that functions as digital media control point, thus notifying the action it can provide, to the third personal computer 50.

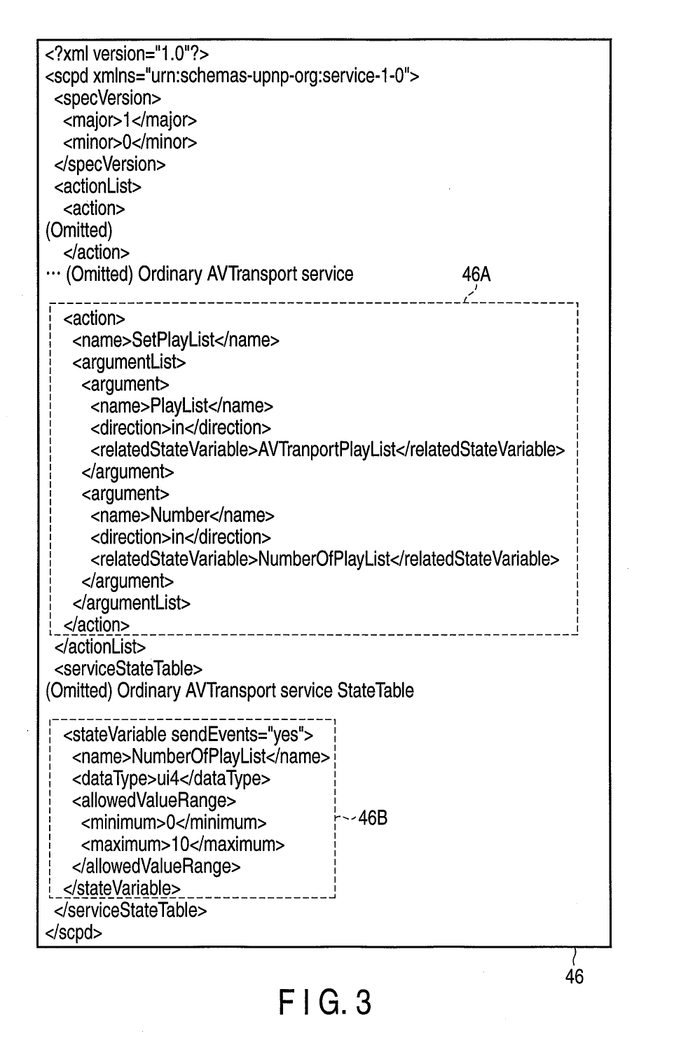

FIG. 3 shows an example of service description 46, which the digital television receiver 40 transmits. In the service description 46, several functions (actions) the digital television receiver 40 can provide are defined between <actionList> and </actionList>. As shown in FIG. 3, service (SetPlayList action) is described in the broken-line box 46A, so that the playlist may be displayed.

Further, action data is described between <serviceStateTable> and </serviceStateTable>. In the broken-line box 46B, a state variable (stateVariable) is described, defining the upper and lower limits of the number of content items that can be described in the playlist. That is, at most 10 titles can be received in the case shown in FIG. 3. The playlist display module 43 prepares a playlist showing 10 titles at most.

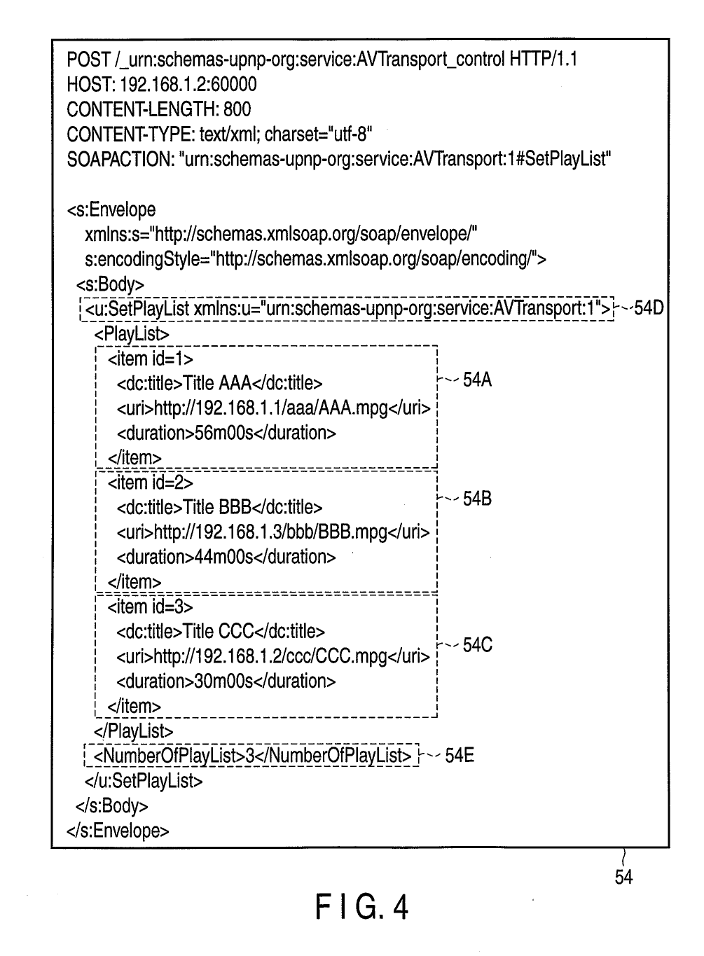

FIG. 4 shows an example of a playlist document 54 transmitted from the digital media control point. As shown in FIG. 4, the data about content item AAA (i.e., title, URI (storage position), and playback time) is described in the broken-line box 54A, the data about content item BBB (i.e., title, URI (storage position), and playback time) is described in the broken-line box 54B, and data about content item CCC (i.e., title, URI (storage position), and playback time) is described in the broken-line box 54C. In each of the boxes 54A, 54B and 54D, which describes the data about a content item, the value of N in <item id=N (N is a positive number)> indicates the order in which to play back the content item. In each box, the text between <dc:title> and </dc:title> indicates the title of the content item. In each box, the text between <uri> and </uri> indicates the position where the text is stored. In each box, the text between <duration> and </duration> indicates the time for which to play back the content item.

In the playlist document 54, a broken-line box 54D shows that the content is a playlist. In the playlist document 54, too, the number of content items listed is described in a broken-line box 54E, more precisely between <NumbeOfPlayList> and </NumbeOfPlayList>. In the present embodiment, “3” is described in the box 54E, showing that three content items are listed.

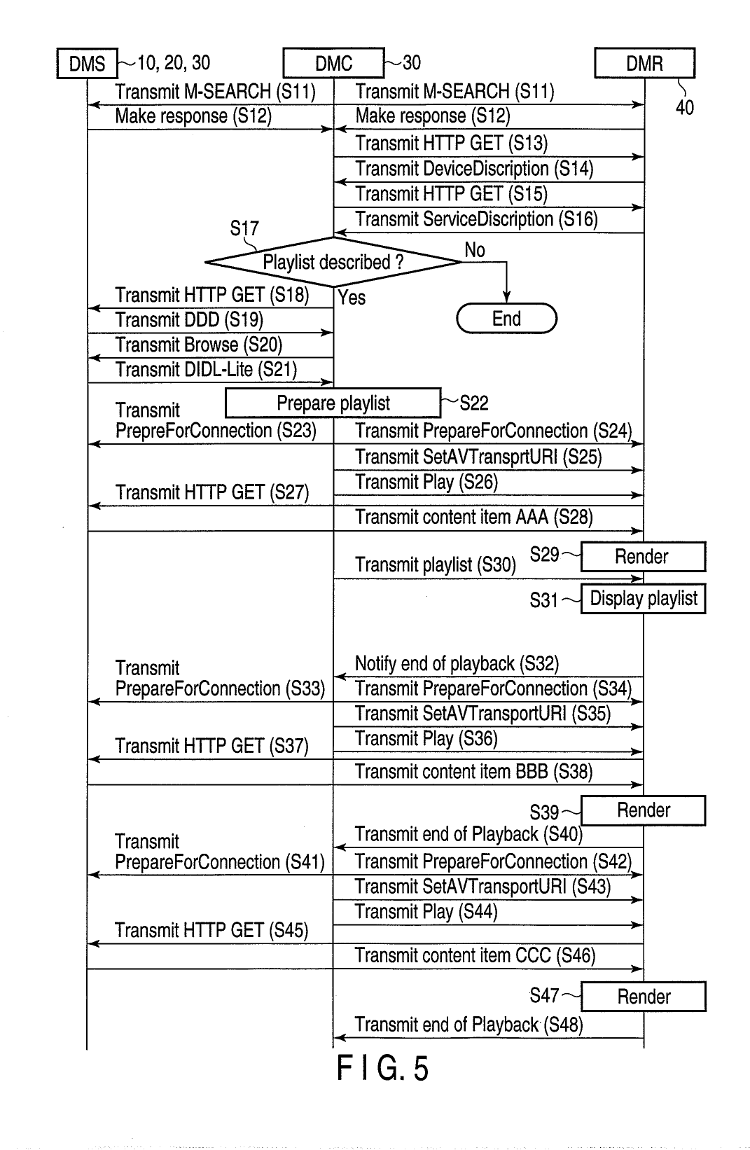

How the playlist of content items is prepared and how the content items are played back in accordance with the playlist will be explained, with reference to FIG. 5. FIG. 5 is a flowchart explaining the sequence of first preparing a playlist of content items and then playing back the content items in accordance with the playlist.

First, the third personal computer (DMC) 50 is activated. Then, the control module 52 controls the communication module 51, causing the same to transmit an M-SEARCH message defined in SSDP to the home network 60 by means of multi-cast transmission (Step S11). The digital broadcast record/playback device (DMS) 10, first personal computer (DMS) 20 and digital television receiver (DMR) 40, which are UPnP-standardized, receive the M-SEARCH message and transmit response M-SEARCH messages to the device that has transmitted the M-SEARCH message, by using the communication module 51 (Step S12). Note that each response M-SEARCH message contains URI (IP address and port number) representing the position of the transmitting device, URI of the device description 45, and the like. On receiving the response M-SEARCH message, the control module 52 detects the digital broadcast record/playback device (DMS) 10, first personal computer (DMS) 20 and digital television receiver (DMR) 40, all connected to the home network 60.

The control module 52 then transmits an HTTP GET message for the URI of the device description 45 contained in the response message (Step S13). On receiving the HTTP GET message, the communication module 41 of the digital television receiver 40 transmits the device description 45 to the third personal computer 50 (Step S14).

The control module 52 transmits an HTTP GET message, also for the URI of the service description 46 contained in the device description 45 (Step S15). On receiving this HTTP GET message, the communication module 41 of the digital television receiver 40 transmits the service description 46 to the third personal computer 50 (Step S16).

The control module 52 of the third personal computer 50 determines whether the service description 46 describes a playlist action (Step S17).

If the service description 46 describes a playlist action (Yes in Step S17), the control module 52 of the third personal computer 50 causes the communication module 51 to transmit an HTTP GET message to the digital broadcast record/playback device 10, first personal computer 20 and second personal computer 30, in response to the URI contained in the response messages the device 10 and computers 20 and 30 have transmitted (Step S18). On receiving the HTTP GET message, the digital broadcast record/playback device 10, first personal computer 20 and second personal computer 30 transmit device description and service description of XML format, which describe device data and service data, respectively, to the third personal computer 50 (Step S19). DIDL-Lite documents may be received, not from all digital media servers, but from only the digital media server the user has selected.

The control module 52 of the third personal computer 50 causes the communication module 51 to transmit a Browse action to the first personal computer 20 and second personal computer 30, in accordance with content directory service (CDS) (Step S20). On receiving the Browse action, the first personal computer 20 and second personal computer 30 transmit, to the third personal computer 50, a DIDL-Lite document of XML format, which contains the list of the content items stored in a memory device (Step S21). The DIDL-Lite document may be received, not from all digital media servers, but from only the digital media server the user has selected.

Referring to the list of the content items held in the DMSs 10, 20 and 30, the user selects or determines the order in which to play back the content items. The playlist preparation module 53 prepares a playlist 54 showing the content items arranged in the order the user has selected or determined (Step S22).

The control module 52 of the third personal computer 50 causes the communication module 51 to transmit a PrePareForConnection action to the digital broadcast record/playback device 10, thereby instructing the device 10 to prepare the connection to the digital television receiver 40 (Step S23). If the digital broadcast record/playback device 10 responds to the digital broadcast record/playback device 10, the control module 52 transmit the PrePareForConnection action to the rendering module 42, thereby instructing the digital television receiver 40 to prepare for connection to the digital broadcast record/playback device 10 (Step S24). If the digital television receiver 40 responds to the PrePareForConnection action, the control module 52 transmits SetAVTransportURI to the rendering module 42 of the digital television receiver 40 (Step S25). The URI of content item AAA is embedded in the parameter of SetAVTransportURI. The URI is described to control PrePareForConnection in this embodiment. Nonetheless, the steps concerning PrePareForConnection may be skipped.

Then, the control module 52 transmits Play to the digital television receiver 40 (Step S26). When the digital television receiver 40 receives Play, the rendering module 42 transmits an HTTP::GET action to the digital broadcast record/playback device 10 (Step S27). The HTT::GET action contains, as parameter, the URI of content item AAA. In response to the parameter of the HTTP::GET action, the digital broadcast record/playback device 10 transmits the data of content item AAA the user has selected, to the digital television receiver 40 (Step S28).

The digital television receiver 40 receives the data of content item AAA selected by the user, by using HTTP, and performs stream playback. When the data of content item AAA is received to a prescribed amount, the digital television receiver 40 starts reproducing (rendering) content item AAA (Step S29).

While content item AAA is being reproduced, the third personal computer 50 transmits the playlist document 54 to the playlist display module 43 of the digital television receiver 40 (Step S30). The playlist display module 43 displays the playlist on the display module 44, on the basis of the playlist document 54 (Step S31). Note that the playlist is displayed, overlapped on the image the rendering module 42 is reproducing.

When content item AAA is completely played back, the rendering module 42 transmits a message to the control module 52 of the third personal computer 50, informing that content item AAA has been played back (Step S32).

The control module 52 of the third personal computer 50 causes the communication module 51 to transmit a PrePareForConnection action to the first personal computer 20, instructing the first personal computer 20 to prepare for connection to digital television receiver 40 (Step S33). If the first personal computer 20 makes a response to the PrePareForConnection action, the control module 52 transmits PrePareForConnection action to the rendering module 42 of the digital television receiver 40, instructing the digital television receiver 40 to prepare for connection to the first personal computer 20 (Step 34). On receiving a response, if any, to PrePareForConnection from the digital television receiver 40, the control module 52 transmits SetAVtransportURI to the rendering module 42 of the digital television receiver 40 (Step S35). The parameter of SetAVtransportURI contains the URI of the content item BBB. This URI is described to control PrePareForConnection in this embodiment. Nonetheless, the steps concerning PrePareForConnection may be skipped.

Then, the control module 52 transmits Play to the digital television receiver 40 (Step S36). When the digital television receiver 40 receives Play, the rendering module 42 transmits an HTTP::GET action to the first personal computer 20 (Step S37). The HTTP::GET action contains the URI of content item BBB, as parameter. In response to the parameter of the HTTP::GET action, the first personal computer 20 transmits the data of content item BBB to the digital television receiver 40 (Step S38).

The digital television receiver 40 receives the data of content item BBB the user has selected, by using HTTP, and performs stream playback. When the data of content item BBB is received to a prescribed amount, the digital television receiver 40 starts reproducing (rendering) content item BBB (Step S39).

When content item BBB is completely played back, the rendering module 42 transmits a message to the control module 52 of the third personal computer 50, informing that content item BBB has been played back (Step S40).

The control module 52 of the third personal computer 50 causes the communication module 51 to transmit a PrePareForConnection action to the second personal computer 30, instructing the second personal computer 30 to prepare for connection to digital television receiver 40 (Step S41). If the second personal computer 30 makes a response to the PrePareForConnection action, the control module 52 transmits PrePareForConnection action to the rendering module 42 of the digital television receiver 40, instructing the digital television receiver 40 to prepare for connection to the second personal computer 30 (Step 42). On receiving a response, if any, to PrePareForConnection from the digital television receiver 40, the control module 52 transmits SetAVtransportURI to the rendering module 42 of the digital television receiver 40 (Step S43). The parameter of SetAVtransportURI contains the URI of the content item CCC. This URI is described to control PrePareForConnection in this embodiment. Nonetheless, the steps concerning PrePareForConnection may be skipped.

Then, the control module 52 transmits Play to the digital television receiver 40 (Step S44). When the digital television receiver 40 receives Play, the rendering module 42 transmits an HTTP::GET action to the third personal computer 50 (Step S45). The HTTP::GET action contains the URI of content item BBB, as parameter. In response to the parameter of the HTTP::GET action, the third personal computer 50 transmits the data of content item CCC to the digital television receiver 40 (Step S46).

Then, the digital television receiver 40 receives the data of content item CCC the user has selected, by using HTTP, and performs stream playback. When the data of content item CCC is received to a prescribed amount, the digital television receiver 40 starts reproducing (rendering) content item CCC (Step S47).

When content item CCC is completely played back, the rendering module 42 transmits a message to the control module 52 of the third personal computer 50, informing that content item CCC has been played back (Step S48).

As the processes are performed in sequence, as described above, the playlist is displayed on the display screen of digital television receiver 40 that functions as renderer. Moreover, the playlist can be prepared even if the third personal computer 50 has no function of a digital media server.

A download module may be used, which downloads any content items other than the content item being played back, in accordance with the content item storage position described in the playlist, and which records these content items in a storage medium such as a local hard disk drive. This module, which downloads content items beforehand, helps to reduce the load on the network and to play back any content item faster.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A communication apparatus comprising:
a renderer configured to receive a content item from a digital media server connected to a network and to display an image of the received content item on a display screen;
a communication module configured to send a service description to a digital media control point connected to the network in response to a request from the digital media control point, wherein the service description comprises an action description indicating that a playlist can be displayed on the display screen; and
a display configured to display, when a playlist document which comprises one or more titles of one or more content items and a playback order of the one or more content items is received from the digital media control point, the one or more titles based on the playback order on the display screen.

2. The communication apparatus of claim 1, wherein the communication module is configured to send the service description, and wherein the service description comprises a variable representing the number of content items that can be described in the playlist document.

3. The communication apparatus of claim 1, wherein the renderer is configured to receive a first content item of the one or more content items from the digital media server and to display an image of the first content item on the display screen in accordance with a command from the digital media control point.

4. The communication apparatus of claim 1, wherein:
the playlist document comprises data representing storage locations at which the one or more content items are stored, and
the communication apparatus further comprises a downloader configured to receive the one or more content items based on the data representing the storage locations.

5. The communication apparatus of claim 1, wherein the service description comprises XML code and accords with the Universal Plug and Play (UPnP) standards.

6. A communication apparatus comprising:
a detector configured to detect a digital media server and a digital media renderer which are connected to a network;
a first receiver configured to receive a content item list from the digital media server detected by the detector, the content item list comprising one or more first titles of one or more first content items which are stored in the digital media server and storing one or more storage locations of the one or more first content items;
a second receiver configured to request the digital media renderer detected by the detector to send a service description, and to receive the service description from the digital media renderer; and
a communication module configured to send a playlist document to the digital media renderer when the service description comprises an action description indicating that a playlist can be displayed on a display screen, the playlist document comprising one or more second titles and playback order of one or more second content items selected from the content item list by user.

7. The communication apparatus of claim 6, wherein:
the service description comprises a variable representing the number of content items that can be described in the playlist document, and
the communication module is configured to send the playlist document based on the number of content items.

8. The communication apparatus of claim 6, wherein the communication module is configured to send the playlist document comprising the one or more storage locations where the one or more content items are stored.

9. The communication apparatus of claim 6, wherein the communication module is configured to send the playlist document while a content item described in the playlist document is being displayed.

10. A display control method comprising:
detecting, by a first communication device, a second communication device and a third communication device which are connected to a network;
requesting communication of a service description from the first communication device to the third communication device;
sending the service description from the third communication device to the first communication device;
receiving, by a first communication device, a content item list comprising the title of one or more content items stored in the second communication device and the one or more storage locations where the one or more content items are stored, from the second communication device detected by the first communication device;
sending a playlist document from the first communication device to the third communication device when the service description comprises an action description indicating that a playlist can be displayed on a display screen of the third communication device, the playlist document comprising the one or more titles and playback order of the one or more content items; and
displaying a playlist based on the playlist document on the display screen.
